(19) United States
(12) Patent Application Publication
(10) Pub. No.: US 2017/0206323 A1
(43) Pub. Date: Jul. 20, 2017

(54) SYSTEMS AND METHODS FOR AUTOMATED ORDER AND NOTIFICATION FOR PATIENT INTERVENTIONS BASED ON HEALTH RECORDS

(71) Applicant: UNITED STATES GOVERNMENT AS REPRESENTED BY THE DEPARTMENT OF VETERANS AFFAIRS, Washington, DC (US)

(72) Inventor: Philip J. EULIE, Rancho Cordova, CA (US)

(21) Appl. No.: 15/480,266

(22) Filed: Apr. 5, 2017

Related U.S. Application Data
(63) Continuation of application No. 14/547,516, filed on Nov. 19, 2014.
(60) Provisional application No. 61/906,288, filed on Nov. 19, 2013.

(51) Int. Cl. G06F 19/00

(52) U.S. Cl. CPC G06F 19/322; G06F 19/3481

(57) ABSTRACT

Systems and methods for automatic order generation and notification for patient interventions. In an embodiment, a data repository comprising a plurality of patient health records is analyzed to identify a subset of the patient health records matching one or more criteria. The presence of the one or more criteria in a patient health record indicates that an associated patient may benefit from one or more interventions. For each patient represented in the subset of patient health records and for each of the one or more interventions, it is determined whether an order for the intervention already exists for the patient. If no order for the intervention already exists, an order for the intervention is generated.

### CROSS-REFERENCE TO RELATED APPLICATIONS

This application claims priority to U.S. patent application No. 14/547,516, filed on Nov. 19, 2014 which claims the benefit of U.S. Provisional Patent App. No. 61/906,288, filed on Nov. 19, 2013, each of which is incorporated by reference in its entirety.

### GOVERNMENT LICENSE RIGHTS

This invention was made with government support under Contract No. GS-06F-0513Z awarded by the Department of Veterans Affairs. The government has certain rights in the invention.

### BACKGROUND

Field of the Invention

The embodiments described herein are generally directed to clinical orders for patient interventions, and, more particularly, to automated ordering of interventions for patients based on an analysis of electronic patient records.

Description of the Related Art

A consensus has developed among experts about what interventions are beneficial for various clinical conditions and—for interventions that should be performed on a recurring basis (e.g., blood tests for glycemic control, HgbA1c, in patients with diabetes mellitus—the maximum time intervals that should pass between interventions. This consensus is reflected in guidelines provided by national and international bodies.

However, currently, ensuring that these tests are performed, and in a timely manner, generally requires that a patient come in for an appointment with a clinician. Consequently, the opportunities for convenient testing are limited. Accordingly, there is a need to develop strategies that more efficiently and conveniently identify patients who are in need of or may benefit from interventions, order those interventions for the patients, and notify the patients of the ordered interventions so that the interventions may be performed in a timely manner for those patients that need and want care.

### SUMMARY

Accordingly, systems and methods are disclosed to apply clinical guidelines to a patient population represented in a data repository, parse or stratify the patient population into clinically meaningful subgroups, apply one or more clinically relevant interventions to one or more of the subgroups, generate orders for the one or more clinically relevant interventions for one or more patients in the one or more subgroups, and/or notify those patients of the interventions and the orders.

In an embodiment, a method for automated intervention ordering is disclosed. The method comprises using at least one hardware processor to: analyze a data repository comprising a plurality of patient health records to identify a subset of the plurality of patient health records matching one or more criteria, wherein a presence of the one or more criteria in a patient health record indicates that an associated patient may benefit from one or more interventions; and, for each patient represented in the subset of patient health records and for each of the one or more interventions, determine whether an order for the intervention already exists for the patient, and, if it is determined that an order for the intervention does not already exist for the patient, generate an order for the intervention.

In an additional embodiment, a system for automated intervention ordering is disclosed. The system comprises: at least one hardware processor; and one or more executable software modules configured to, when executed by the at least one hardware processor, analyze a data repository comprising a plurality of patient health records to identify a subset of the plurality of patient health records matching one or more criteria, wherein a presence of the one or more criteria in a patient health record indicates that an associated patient may benefit from one or more interventions, and, for each patient represented in the subset of patient health records and for each of the one or more interventions, determine whether an order for the intervention already exists for the patient, and, if it is determined that an order for the intervention does not already exist for the patient, generate an order for the intervention.

In a further embodiment, one or more sequences of instructions stored on a non-transitory computer-readable medium are disclosed. The one or more sequences of instructions, when executed by a processor, cause the processor to: analyze a data repository comprising a plurality of patient health records to identify a subset of the plurality of patient health records matching one or more criteria, wherein a presence of the one or more criteria in a patient health record indicates that an associated patient may benefit from one or more interventions; and, for each patient represented in the subset of patient health records and for each of the one or more interventions, determine whether an order for the intervention already exists for the patient, and, if it is determined that an order for the intervention does not already exist for the patient, generate an order for the intervention.

In an embodiment, after an order has been generated for an intervention, and optionally verified/approved (e.g., signed by a provider) and activated, the patient associated with the order may be notified. This notification may be automatic and may utilize a variety of modalities, including, without limitation, a telephone call, fax, text message, email message, postcard, letter, and/or the like.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure within which the disclosed systems and processes may operate, according to an embodiment;

FIG. 2 illustrates an example process for automated ordering, according to an embodiment;

FIG. 3 illustrates an example process for automated intervention notification, according to an embodiment; and

FIG. 4 illustrates a processing system on which one or more of the methods described herein may be executed, according to an embodiment.

### DETAILED DESCRIPTION

In an embodiment, systems and methods are disclosed for identifying patients who may benefit from specific interventions and automatically generating orders and/or order notifications for those identified patients. Examples of interventions may include, without limitation, laboratory tests (e.g., cholesterol tests, blood tests, urine tests, etc.), radiology tests, consultations (e.g., eye consults for retinal screening, gastrointestinal consults for a colonoscopy screening, etc.), and the like. The patients benefitting from interventions may be identified based on published clinical practice guidelines.

In an embodiment, the system operates using an electronic health record repository and/or other clinical, administrative, and/or demographic data repository or repositories. For instance, the repository may comprise the electronic health record (EHR) utilized by the U.S. Department of Veterans Affairs. The EHR began as a data repository for demographic and administrative information. Subsequently, laboratory and radiological features (e.g., laboratory and radiological results) were added, followed by the addition of clinical notes. The EHR presently provides functions that allow just-in-time information relevant to a patient, such as clinical reminders for interventions. These clinical reminders can be tailored to a specific patient based on demographic, clinical, and/or administrative data.

The current EHR of the U.S. Department of Veterans Affairs is clinician-centric. However, there is an increasing need to develop a patient-centric health record that would allow the patient to review his or her clinical information, communicate and collaborate with his or her clinicians, and take greater responsibility for his or her health care. Embodiments of the auto-ordering functions disclosed herein, when applied to a health record, move the health record towards a more patient-centric paradigm. In a sense, the disclosed auto-ordering systems and methods enable the health record to which they are applied to “reach out” to the patient and provide relevant and timely interventions based on the patient's demographics and/or clinical histories.

In an embodiment, the disclosed systems and methods search a data repository (e.g., EHR) to identify patients that require or may benefit from specific interventions. This may be done in accordance with published or accepted clinical practice guidelines. For each patient that is identified as potentially benefiting from an intervention, it is determined whether an order for the intervention already exists. If no such order exists, an order for the intervention is generated. Then, once the order is generated or if an order already existed but was not previously verified or approved, the order may wait for verification (e.g., by a physician) as to its appropriateness. For instance, verification of an order may comprise an electronic or handwritten signature by the patient's physician.

Once the order has been verified, it can be activated, and the patient may be notified of the order. This notification may comprise one or more of a telephone message, text or multimedia message, email message, secure message, letter or postcard, or other method of communication.

In an embodiment, the disclosed systems and methods may improve the convenience of interventions by facilitating the scheduling of those interventions during previously existing appointment times. For example, the systems and methods may identify subgroup(s) of patients with upcoming appointments who may benefit from one or more interventions. Orders for those interventions may then be generated for the identified subgroup of patients, and, optionally, may even be scheduled for the previously scheduled appointment times. Once the orders are verified and activated, the patients may also be notified.

System Overview

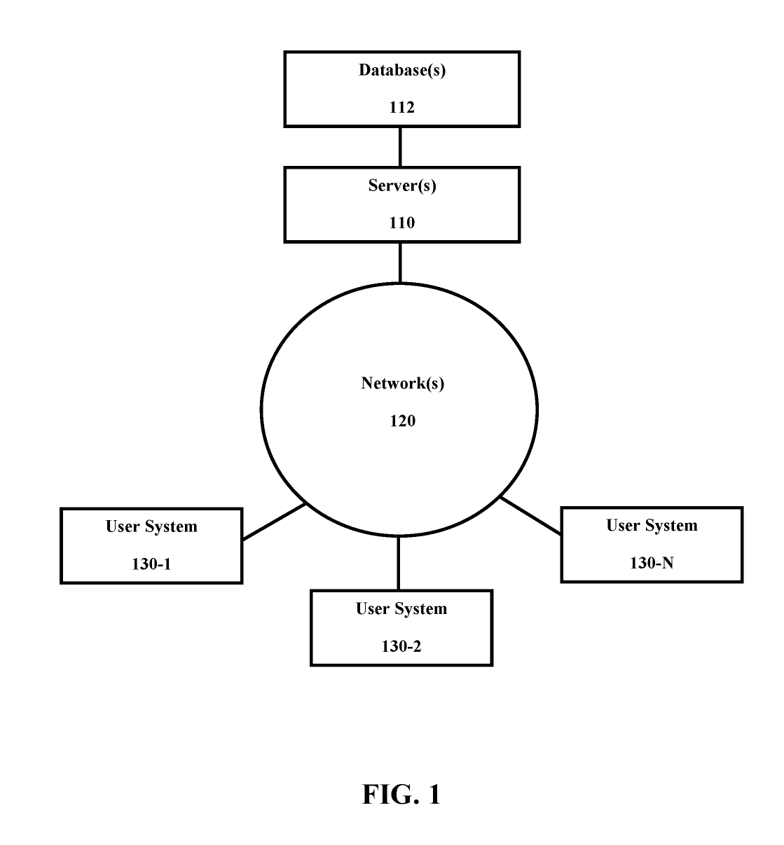

FIG. 1 illustrates an example system for automated order generation and/or notification, according to an embodiment. The system may comprise a set of one or more servers 110 (also referred to herein as a “platform”) which host and/or execute one or more of the various functions, methods, processes, and/or software modules described herein. In addition, server(s) 110 may be communicatively connected to one or more user systems 130 via one or more network(s) 120, and may also be communicatively connected to one or more database(s) 112 (e.g., via one or more network(s), such as network(s) 120) and/or may comprise one or more database(s) 112. Network(s) 120 may comprise the Internet, and server(s) 110 may communicate with user system(s) 130 through the Internet using standard transmission protocols, such as HyperText Transfer Protocol (HTTP), Secure HTTP (HTTPS), File Transfer Protocol (FTP), FTP Secure (FTPS), SSH FTP (SFTP), and the like, as well as proprietary protocols. In an embodiment, server(s) 110 may not be dedicated servers, and may instead be cloud instances, which utilize shared resources of one or more servers. It should also be understood that server(s) 110 may be, but are not required to be, collocated. Furthermore, while server(s) 110 are illustrated as being connected to various systems through a single set of network(s) 120, it should be understood that server(s) 110 may be connected to the various systems via different sets of one or more networks. For example, server(s) 110 may be connected to a subset of user systems 130 via the Internet, but may be connected to one or more other user systems 130 via an intranet. It should also be understood that user system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, Automated Teller Machines, and the like. In addition, while only a few user systems 130, one set of server(s) 110, and one set of database(s) 112 are illustrated, it should be understood that the network may comprise any number of user systems, sets of server(s), and database(s).

Platform 110 may comprise web servers which host one or more websites or web services. In embodiments in which a website is provided, the website may comprise one or more user interfaces, including, for example, webpages generated in HyperText Markup Language (HTML) or other language. Platform 110 transmits or serves these user interfaces in response to requests from user system(s) 130. In some embodiments, these user interfaces may be served in the form of a wizard, in which case two or more user interfaces may be served in a sequential manner, and one or more of the sequential user interfaces may depend on an interaction of the user or user system with one or more preceding user interfaces. The requests to platform 110 and the responses from platform 110, including the user interfaces, may both be communicated through network(s) 120, which may include the Internet, using standard communication protocols (e.g., HTTP, HTTPS). These user interfaces or web pages may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (not shown) that are locally and/or remotely accessible to platform 110. Platform 110 may also respond to other requests from user system(s) 130.

Platform 110 may further comprise, be communicatively coupled with, or otherwise have access to one or more database(s) 112. For example, platform 110 may comprise one or more database servers which manage one or more databases 112. A user system 130 or application executing on platform 110 may submit data (e.g., user data, form data, etc.) to be stored in database(s) 112, and/or request access to data stored in such database(s) 112. Any suitable database may be utilized, including without limitation MySQL™, Oracle™, IBM™, Microsoft SQL™, Sybase™, Access™, and the like, including cloud-based database instances and proprietary databases. Data may be sent to platform 110, for instance, using the well-known POST request supported by HTTP, via FTP, etc. This data, as well as other requests, may be handled, for example, by server-side web technology, such as a servlet or other software module, executed by platform 110.

In embodiments in which a web service is provided, platform 110 may receive requests from user system(s) 130, and provide responses in eXtensible Markup Language (XML) and/or any other suitable or desired format. In such embodiments, platform 110 may provide an application programming interface (API) which defines the manner in which user system(s) 130 may interact with the web service. Thus, user system(s) 130, which may themselves be servers, can define their own user interfaces, and rely on the web service to implement or otherwise provide the backend processes, methods, functionality, storage, etc., described herein. For example, in such an embodiment, a client application executing on one or more user system(s) 130 may interact with a server application executing on platform 110 to execute one or more or a portion of one or more of the various functions, processes, methods, and/or software modules described herein. The client application may be “thin,” in which case processing is primarily carried out server-side by platform 110. A basic example of a thin client application is a browser application, which simply requests, receives, and renders web pages at user system(s) 130, while platform 110 is responsible for generating the web pages and managing database functions. Alternatively, the client application may be “thick,” in which case processing is primarily carried out client-side by user system(s) 130. It should be understood that the client application may perform an amount of processing, relative to platform 110, at any point along this spectrum between “thin” and “thick,” depending on the design goals of the particular implementation. In any case, the application, which may wholly reside on either platform 110 or user system(s) 130 or be distributed between platform 110 and user system(s) 130, can comprise one or more executable software modules that implement one or more of the processes, methods, or functions of the application(s) described herein.

Process Overview

Embodiments of processes for automated ordering and notification will now be described in detail. It should be understood that the described processes may be embodied in one or more software modules that are executed by one or more hardware processors, e.g., as the application discussed above, which may be executed wholly by processor(s) of platform 110, wholly by processor(s) of user system(s) 130, or may be distributed across platform 110 and user system(s) 130 such that some portions or modules of the application are executed by platform 110 and other portions or modules of the application are executed by user system(s) 130. The described process may implemented as instructions represented in source code, object code, and/or machine code. These instructions may be executed directly by the hardware processor(s), or alternatively, may be executed by a virtual machine operating between the object code and the hardware processors. In addition, the disclosed application may be built upon or interfaced with one or more existing systems (e.g., a patient reminder or appointment system, order management system, etc.).

Automatic Ordering.

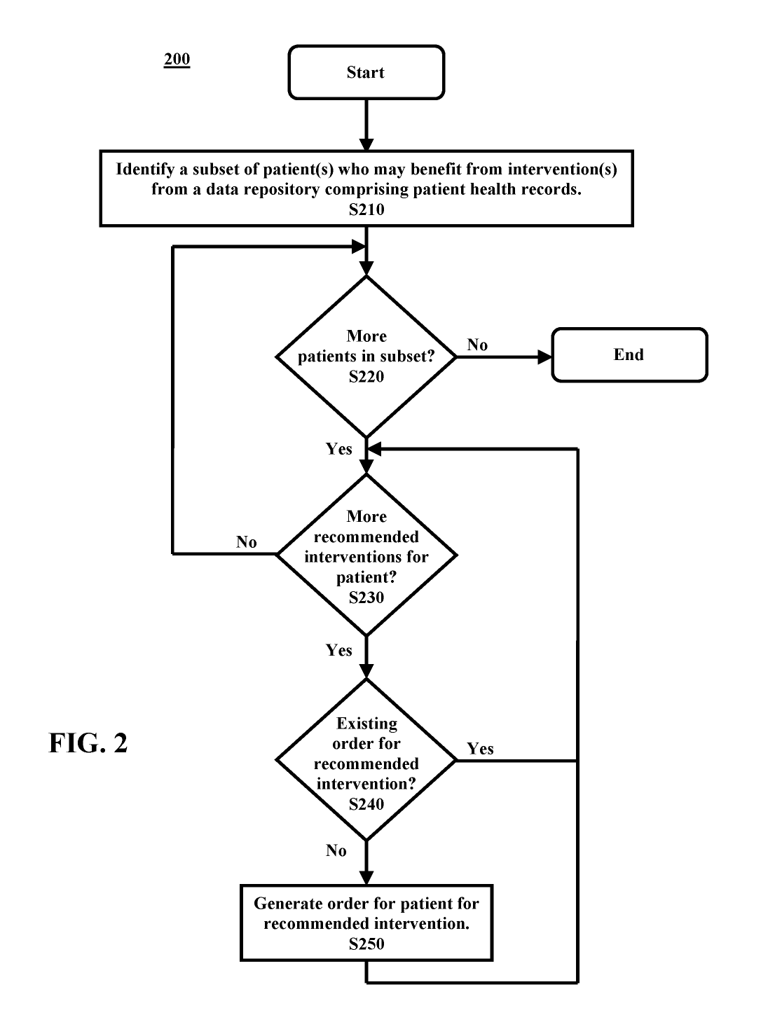

FIG. 2 illustrates an example process 200 for automatic order generation, according to an embodiment. Beginning in step S210, a subset of patients who may benefit from one or more interventions are identified from a data repository (e.g., stored as database(s) 112) that comprises health records and/or other data for a plurality of patients. It should be understood that the data repository may actually comprise a plurality of distributed data repositories or multiple data storage and retrieval systems, such as the Computerized Patient Record System (CPRS) and EHR of the U.S. Department of Veterans Affairs.

Step S210 may be implemented as a search or retrieval module of the application that comprises or is interfaced with the data repository (e.g., via an API defining one or more remote procedure calls). For instance, in embodiments which interface with the data repository, the module may establish a connection with the data repository (e.g., over one or more networks) and search and/or retrieve data from the data repository (e.g., using one or more remote procedure calls or other interactions).

The subset of patients to be processed for automatic order generation may be identified by searching the data repository for health records that comprise one or more criteria. These criteria may be determined according to accepted clinical practice guidelines. For example, it is generally recommended that individuals with a vascular disease undergo a cholesterol test at least once a year. Thus, the search module may search the patient health records to identify a subset of patients with vascular disease who have not had a cholesterol test within the past year, and thus, are candidates for an intervention comprising a cholesterol test. It should be understood that the search module may search for a variety of criteria corresponding to a variety of interventions. These interventions may comprise, for instance, laboratory tests and/or consultations. Examples of consultations include eye consultations (e.g., for retinal screens) and gastrointestinal consultations (e.g., for colonoscopy screens).

In an embodiment, each of the patient health records in the data repository comprises or is associated with existing orders, clinical notes, demographic information, and/or clinical reports (e.g., laboratory reports or data, radiology reports or data, etc.) for the patient. Thus, the search module may access and analyze or evaluate all or a portion of this data to determine what, if any, intervention(s) may benefit the patient.

In an embodiment, each patient health record in the data repository may further comprise, be associated with, or be cross-referenced with appointment information for past and/or future appointments of the associated patient (e.g., reminder information for past and/or future appointments with a clinician). In such an embodiment, the application may utilize this information to determine whether or not to include a patient in the subset to be processed or how to generate an order when the patient is subsequently processed. For instance, this appointment information may be used to include or identify in the subset to be processed those patients who have an upcoming appointment scheduled, e.g., within a defined future time range (e.g., the next 3 months, 6 months, year, etc.). In this manner, the subset of patients to be processed for automatic ordering may only comprise those patients who satisfy the predetermined criteria and have an upcoming appointment (e.g., with a physician or provider). Alternatively, the subset of patients may comprise all patients who satisfy the predetermined criteria, but identify or otherwise distinguish those patients who have upcoming appointments and/or those patients who do not have upcoming appointments. For those patients who are identified as having upcoming appointments, any order generated in the subsequent steps may be scheduled or otherwise timed so as to correspond with the upcoming appointment, thereby improving convenience for the patients. For those patients who are identified as not having upcoming appointments are not identified as having upcoming appointments, any order generated in the subsequent steps may be scheduled or otherwise timed as appropriate or needed.

In an embodiment, the search module analyzes patient health records from the data repository and/or appointment information to identify those patients who need clinical reminders because they will soon need or are past due for routine interventions to manage their chronic conditions. This module may also be configured to activate clinical reminder reports, for example, in response to a user interaction or other triggering event. The clinical reminder reports may be user-configurable via one or more user interfaces provided by the module or other module of the application. The activation of a clinical reminder report may initiate step S210 to identify the subset of patients for the automatic-ordering sub-process beginning with step S220, based on one or more criteria specified in the clinical reminder report.

Once a subset of patients are identified in step S210, process 200 proceeds to step S220, which iterates through each of the identified patients' health records. Step S220 may be implemented as an auto-order module of the application and may be interfaced with an order management module of the application or a separate application (e.g., to retrieve and/or pass order information). For each of the identified patients, process 200 initiates the sub-process beginning with step S230. Once all identified patients in the subset have been processed by the sub-process beginning with step 230, process 200 ends. Alternatively, process 200 may return to step S210 and block until a further subset of patients, who may benefit from intervention(s), are identified.

For each patient in the subset, there will be one or more recommended interventions, as determined in step S210. Thus, in step S230, the process iterates through each of the one or more recommended interventions for the patient. In other words, for each of the recommended intervention(s), process 200 initiates the sub-process beginning with step S240. Once all recommended intervention(s) have been processed by the sub-process beginning with step S240, process 200 returns to step S220 to determine whether any more patients remain to be examined in the identified subset.

In step S240, it is determined, for each of the recommended interventions for each of the patients, whether an order for the recommended intervention already exists. For instance, process 200 may search the patient's health record, or other data of the data repository or retrieved from another system, to determine whether an order corresponding to the recommended intervention and associated with the patient already exists. As an example, if the recommended intervention is a blood test, the patient's health record may be searched to determine whether an existing order for a blood test is associated with the patient. If an existing order is identified in step S240, process 200 returns to step S230 to determine whether any more recommended interventions remain to be processed for the patient.

On the other hand, if an existing order is not identified in step S240, an order is automatically generated for the recommended intervention and associated with the patient in step S250. Step S250 may be implemented by an order generation module of the application. The order generation module may define an order using one or more templates comprising one or more tags or other field identifiers acting as placeholders for variable values. To generate an order, the template is retrieved and the placeholders (e.g., field identifiers) are replaced with values from the patient health record and/or other sources. A plurality of order templates may be provided for a plurality of order types. For example, different order templates may be provided and utilized based on the type of intervention (e.g., laboratory test v. consultation, one type of laboratory test v. another type of laboratory test, one type of consultation v. another type of consultation, etc.), whether or not the order is a co-managed care order, etc. The order generation process may also comprise inserting the order in the patient's health record or associating the order with the patient's health record, storing the order for subsequent processing, and/or entering the order into or passing the order to an order management system or module. In an embodiment, a physician or other clinician associated with the order may be notified (e.g., via secure messaging, email message, etc.) that the order was generated. Once the order is generated, process 200 returns to step S230 to determine whether any more recommended interventions remain to be processed for the patient.

In an embodiment, each order may comprise or be associated with a unique identifier of the order, a patient identifier, a physician and/or provider identifier, an intervention identifier or description, and/or a status. In an embodiment, the status may be a field comprising one of a plurality of values representing the status of the order. For example, the status field may be set to one of a set of values representing that either the order is unsigned, the order is signed but unprocessed, the order is processed but not completed (e.g., no laboratory or radiological results reported), or the order is completed.

Order Activation and Notification.

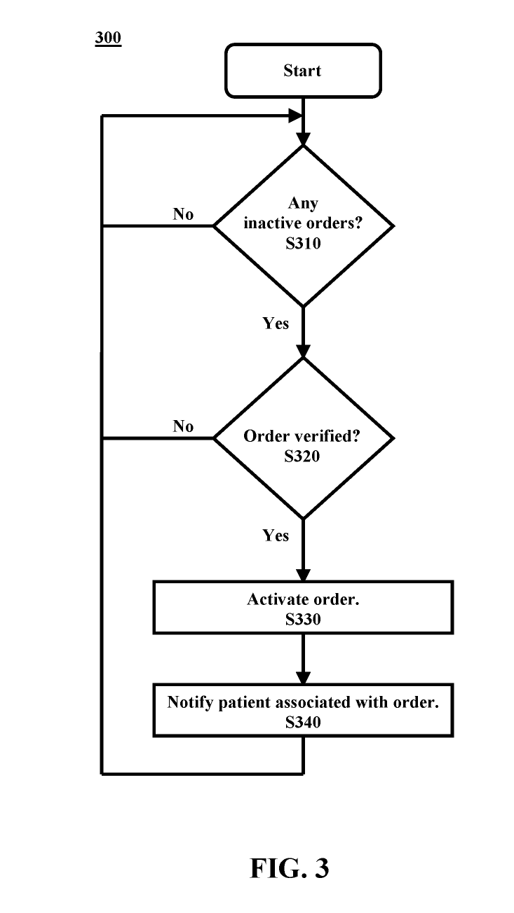

FIG. 3 illustrates an example process for order activation and notification, according to an embodiment. Process 300 may be implemented as an order processing module of the application. Beginning in step S310, process 300 iterates through each inactive order. For instance, the order processing module may search through at least a portion of the data repository (e.g., patient health records or other data comprising information about orders for intervention) or retrieve order information from an order management module of the application or a separate application or system to identify inactive orders for processing. For each identified inactive order, process 300 initiates the sub-process beginning with step S320. Once all inactive orders have been processed by the sub-process beginning with step S320, process 300 may block until further inactive orders are identified or, alternatively, may end.

In step S320, for each of the identified inactive orders, it is determined whether the order has been verified. In an embodiment, an order is verified once it has been approved by the patient's physician, e.g., via a digital or physical signature input through a user interface provided by an order management module of the application or a separate application or system. For example, verification may be indicated by a field and value in the order (e.g., the status field described above, Boolean value, etc.) or associated with the order. In an embodiment, the verification represents an approval by a clinician, e.g., a physician associated with the order or associated with the patient associated with the order. If the order has been verified, then the order is activated in step S330.

Once the order is activated in step S330, the patient associated with the order may be notified in step S340. For example, a notification may be generated and communicated to the patient via one or more communication modules. In an embodiment, step S340 may be implemented as a notification module that comprises or is interfaced with one or more communication modules of the application or a separate application or system, such as a telephone system, an email system (e.g., a Simple Mail Transfer Protocol (SMTP) server), a secure messaging system, other messaging system (e.g., Short Message Service (SMS) system, Multimedia Messaging Service (MMS) system, etc.), a letter or postcard printer or printing system, and/or the like. Accordingly, the notification may include, without limitation, a telephone call, an email message, secure message, text message (e.g., comprising text only with no video, audio, images, or animation), multimedia message (e.g., comprising text, images, video, and/or audio), letter or postcard, and/or the like.

In embodiments which comprise or interface with a telephone module or system, automatic telephone calls may be placed to the patient associated with the order. These telephone calls may comprise pre-recorded audio messages, which may be made in the voice of the patient's physician or in the voice of the provider of the intervention. For instance, the application may comprise a module (e.g., the notification module) that provides a user interface (e.g., via a web server) that allows a physician or provider to record audio (e.g., using a microphone of the physician's or provider's user system 130). Subsequently, a telephone number may be retrieved from a patient's health record, a telephone call may be placed via the integral or interfaced telephone system, and the recorded audio may be played back to the patient via the telephone call to notify the patient of the need or recommendation of an intervention. Alternatively, or as a default (e.g., if the physician or provider does not provide his or her own audio message), the application may provide a generic audio message that can be used.

In embodiments which comprise or interface with other communication module(s) or system(s), such as email systems, secure messaging systems, SMS and/or MMS systems, and/or postcard or letter printing systems, the notification may be defined using one or more templates comprising one or more tags or other field identifiers acting as placeholders for variable values. To generate a notification, the template is retrieved and the placeholders (e.g., field identifiers) are replaced with values from and/or associated with the patient health record and/or other sources, such as the patient's name, patient's address, provider's name, provider's address, proposed or scheduled date and time of intervention, etc. The generated notification may then be passed to the applicable communication module(s) or system(s). A plurality of notification templates may be provided for a plurality of communication systems and/or a plurality of order types. For example, different notification templates may be provided and utilized based on the type of intervention, whether or not the order is a co-managed care order, etc.

In an embodiment, at least some of the orders may be co-managed care orders. A co-managed care order is an order that has been filed within a health system (e.g., the health system of the U.S. Department of Veterans Affairs) but comprises a reference to an order that has taken place outside that health system. The application may maintain a list of patients who require co-managed care orders or the electronic health records may indicate whether a patient requires co-managed care orders. In any case, prior to generating an order for a patient, the application (e.g., the order generation module discussed above) may determine whether a patient requires a co-managed care order (e.g., by cross-referencing the patient to the list or checking the patient health record, depending on the embodiment), and, if so, generate a co-managed care order, and, if not, generate a regular order. For co-managed care orders, the application or other application or system can enable contact with the associated patient's outside physician or provider's office and can otherwise ensure coordinated medical care.

In an embodiment, the application may also comprise an order update module that is configured to identify whether ordered interventions have been performed and/or completed. For example, the order update module may access the patient health records or other data of the data repository or a separate order management system to retrieve order information. The order update module may then analyze the retrieved order information (e.g., examine one or more fields of the order information) to determine whether ordered interventions have been performed and/or completed. If this analysis determined that the status of an order has changed, the order update module may update the status field of the order to reflect the change in status.

For a patient with a co-managed care order, the order update module may be configured to request the order information regarding the associated intervention from the patient's outside physician's or other clinician's or provider's office, in order to determine whether the intervention was performed and/or completed, and/or what the outcome of the intervention was. For instance, the co-managed care order may comprise or be associated with the outside clinician's office or facsimile number, and the order update module may comprise or be interfaced with a telephone or facsimile module or system that can be used to call or fax a request for information. Alternatively, the order update module (e.g., on platform 110) may interface with an electronic records system (e.g., user system 130) of the outside clinician to retrieve the information (e.g., via an API) over one or more networks (e.g., network(s) 120).

In an embodiment, the application may comprise one or more modules that are configured to compile a list of patients who did not have an ordered intervention performed either within a prescribed time period since notification or, if the notification was based on an upcoming appointment, within a prescribed time period since the appointment. For example, the module(s) may analyze the order information to identify those patients who are associated with an unperformed or incomplete order. The module(s) may be configured to provide this list to one or more other systems or modules, either on its own or in response to a request or other triggering event.

In an embodiment, the application may comprise one or more modules that provide a user interface for interacting with the application, such as viewing the subset of patients identified for interventions, viewing lists of generated, verified, activated, and/or incomplete orders, viewing and/or verifying individual orders, adding or modifying order templates, adding or modifying notification templates, adding or modifying audio recordings for telephone notifications, viewing lists of past due interventions, and the like. Alternatively or additionally, the application may be integrated or interfaced with another application which provides a composite user interface (e.g., a dashboard) including information retrieved from the application (e.g., via an API provided by the application) along with information obtained from other modules, applications, or systems.

In an embodiment, the application may implement or require authentication to access one or more features, e.g., to access one or more of the user interfaces or data objects described above.

Example Processing Device

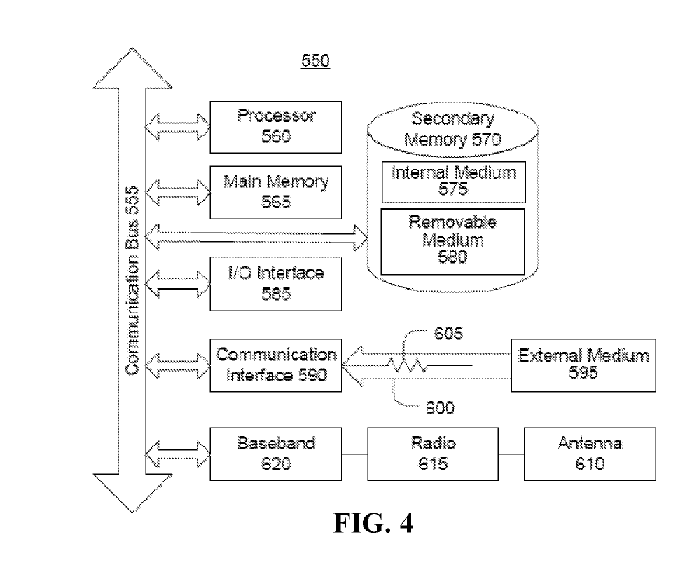

FIG. 4 is a block diagram illustrating an example wired or wireless system 550 that may be used in connection with various embodiments described herein. For example the system 550 may be used as or in conjunction with one or more of the mechanisms, processes, methods, or functions (e.g., to store and/or execute the application or one or more software modules of the application) described above, and may represent components of server(s) 110, user system(s) 130, and/or other devices described herein. The system 550 can be a server or any conventional personal computer, or any other processor-enabled device that is capable of wired or wireless data communication. Other computer systems and/or architectures may be also used, as will be clear to those skilled in the art.

The system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560. Examples of processors which may be used with system 550 include, without limitation, the Pentium® processor, Core i7® processor, and Xeon® processor, all of which are available from Intel Corporation of Santa Clara, Calif.

The processor 560 is preferably connected to a communication bus 555. The communication bus 555 may include a data channel for facilitating information transfer between storage and other peripheral components of the system 550. The communication bus 555 further may provide a set of signals used for communication with the processor 560, including a data bus, address bus, and control bus (not shown). The communication bus 555 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, or standards promulgated by the Institute of Electrical and Electronics Engineers (IEEE) including IEEE 488 general-purpose interface bus (GPIB), IEEE 696/S-100, and the like.

System 550 preferably includes a main memory 565 and may also include a secondary memory 570. The main memory 565 provides storage of instructions and data for programs executing on the processor 560, such as one or more of the functions and/or modules discussed above. It should be understood that programs stored in the memory and executed by processor 560 may be written and/or compiled according to any suitable language, including without limitation C/C++, Java, JavaScript, Perl, Visual Basic, .NET, and the like. The main memory 565 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

The secondary memory 570 may optionally include an internal memory 575 and/or a removable medium 580, for example a floppy disk drive, a magnetic tape drive, a compact disc (CD) drive, a digital versatile disc (DVD) drive, other optical drive, a flash memory drive, etc. The removable medium 580 is read from and/or written to in a well-known manner. Removable storage medium 580 may be, for example, a floppy disk, magnetic tape, CD, DVD, SD card, etc.

The removable storage medium 580 is a non-transitory computer-readable medium having stored thereon computer executable code (i.e., software) and/or data. The computer software or data stored on the removable storage medium 580 is read into the system 550 for execution by the processor 560.

In alternative embodiments, secondary memory 570 may include other similar means for allowing computer programs or other data or instructions to be loaded into the system 550. Such means may include, for example, an external storage medium 595 and an interface 590. Examples of external storage medium 595 may include an external hard disk drive or an external optical drive, or and external magneto-optical drive.

Other examples of secondary memory 570 may include semiconductor-based memory such as programmable read-only memory (PROM), erasable programmable read-only memory (EPROM), electrically erasable read-only memory (EEPROM), or flash memory (block-oriented memory similar to EEPROM). Also included are any other removable storage media 580 and communication interface 590, which allow software and data to be transferred from an external medium 595 to the system 550.

System 550 may include a communication interface 590. The communication interface 590 allows software and data to be transferred between system 550 and external devices (e.g. printers), networks, or information sources. For example, computer software or executable code may be transferred to system 550 from a network server via communication interface 590. Examples of communication interface 590 include a built-in network adapter, network interface card (NIC), Personal Computer Memory Card International Association (PCMCIA) network card, card bus network adapter, wireless network adapter, Universal Serial Bus (USB) network adapter, modem, a network interface card (NIC), a wireless data card, a communications port, an infrared interface, an IEEE 1394 fire-wire, or any other device capable of interfacing system 550 with a network or another computing device.

Communication interface 590 preferably implements industry promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 590 are generally in the form of electrical communication signals 605. These signals 605 are preferably provided to communication interface 590 via a communication channel 600. In one embodiment, the communication channel 600 may be a wired or wireless network, or any variety of other communication links. Communication channel 600 carries signals 605 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software, such as the disclosed application) is stored in the main memory 565 and/or the secondary memory 570. Computer programs can also be received via communication interface 590 and stored in the main memory 565 and/or the secondary memory 570. Such computer programs, when executed, enable the system 550 to perform the various functions of the present invention as previously described.

In this description, the term “computer readable medium” is used to refer to any non-transitory computer readable storage media used to provide computer executable code (e.g., software and computer programs) to the system 550. Examples of these media include main memory 565, secondary memory 570 (including internal memory 575, removable medium 580, and external storage medium 595), and any peripheral device communicatively coupled with communication interface 590 (including a network information server or other network device). These non-transitory computer readable mediums are means for providing executable code, programming instructions, and software to the system 550.

In an embodiment that is implemented using software, the software may be stored on a computer readable medium and loaded into the system 550 by way of removable medium 580, I/O interface 585, or communication interface 590. In such an embodiment, the software is loaded into the system 550 in the form of electrical communication signals 605. The software, when executed by the processor 560, preferably causes the processor 560 to perform the inventive features and functions previously described herein.

In an embodiment, I/O interface 585 provides an interface between one or more components of system 550 and one or more input and/or output devices. Example input devices include, without limitation, keyboards, touch screens or other touch-sensitive devices, biometric sensing devices, computer mice, trackballs, pen-based pointing devices, and the like. Examples of output devices include, without limitation, cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), and the like.

The system 550 also includes optional wireless communication components that facilitate wireless communication over a voice and over a data network. The wireless communication components comprise an antenna system 610, a radio system 615 and a baseband system 620. In the system 550, radio frequency (RF) signals are transmitted and received over the air by the antenna system 610 under the management of the radio system 615.

In one embodiment, the antenna system 610 may comprise one or more antennae and one or more multiplexors (not shown) that perform a switching function to provide the antenna system 610 with transmit and receive signal paths. In the receive path, received RF signals can be coupled from a multiplexor to a low noise amplifier (not shown) that amplifies the received RF signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission.

The baseband system 620 is also communicatively coupled with the processor 560. The central processing unit 560 has access to data storage areas 565 and 570. The central processing unit 560 is preferably configured to execute instructions (i.e., computer programs or software) that can be stored in the memory 565 or the secondary memory 570. Computer programs can also be received from the baseband processor 610 and stored in the data storage area 565 or in secondary memory 570, or executed upon receipt. Such computer programs, when executed, enable the system 550 to perform the various functions of the present invention as previously described. For example, data storage areas 565 may include various software modules (not shown).

Various embodiments may also be implemented primarily in hardware using, for example, components such as application specific integrated circuits (ASICs), or field programmable gate arrays (FPGAs). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, functions, and methods described in connection with the embodiments disclosed herein can be implemented or performed with a general purpose processor, a digital signal processor (DSP), an ASIC, FPGA, or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such that the processor can read information from, and write information to, the storage medium. In the alternative, the storage medium can be integral to the processor. The processor and the storage medium can also reside in an ASIC.

Any of the software components described herein may take a variety of forms. For example, a component may be a stand-alone software package, or it may be a software package incorporated as a “tool” in a larger software product. It may be downloadable from a network, for example, a website, as a stand-alone product or as an add-in package for installation in an existing software application. It may also be available as a client-server software application, as a web-enabled software application, and/or as a mobile application.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

What is claimed is:

1. A method for automated intervention ordering, the method comprising using at least one hardware processor to:
analyze a data repository comprising a plurality of patient health records to identify a subset of the plurality of patient health records matching one or more criteria, wherein a presence of the one or more criteria in a patient health record indicates that an associated patient may benefit from one or more interventions; and,
for each patient represented in the subset of patient health records and for each of the one or more interventions,
determine whether an order for the intervention already exists for the patient, and,
if it is determined that an order for the intervention does not already exist for the patient, generate an order for the intervention.

2. The method of claim 1, further comprising using the at least one hardware processor to, for each patient represented in the subset of patient health records and for each of the one or more interventions, if an order for the intervention is generated, notify a physician associated with the patient of the generated order.

3. The method of claim 2, further comprising using the at least one hardware processor to, for one or more orders, receive a verification of the order.

4. The method of claim 3, wherein the verification comprises an indication of approval by a physician.

5. The method of claim 1, further comprising using the at least one hardware processor to:
identify an inactive subset of orders from a plurality of orders; and,
for each of the inactive subset of orders,
determine whether the order has been verified, and,
if it is determined that the order has been verified, activate the order and send a notification to a patient associated with the order.

6. The method of claim 5, wherein the notification comprises one or more of a telephone call, email message, secure message, text message, multimedia message, letter, and postcard.

7. The method of claim 1, wherein the one or more criteria comprise an upcoming appointment.

8. The method of claim 1, further comprising using the at least one hardware processor to, for each patient represented in the subset of patient health records:
determine whether the patient has an upcoming appointment; and,
if it is determined that the patient has an upcoming appointment, distinguish the patient from other patients that do not have an upcoming appointment.

9. The method of claim 1, wherein the one or more interventions comprise one or more of a laboratory test and consultation.

10. The method of claim 1, wherein each of the plurality of patient health records comprises one or more of existing orders, clinical notes, demographic information, and clinical reports for the associated patient.

11. A system for automated intervention ordering, the system comprising:
at least one hardware processor; and
one or more executable software modules configured to, when executed by the at least one hardware processor,
analyze a data repository comprising a plurality of patient health records to identify a subset of the plurality of patient health records matching one or more criteria, wherein a presence of the one or more criteria in a patient health record indicates that an associated patient may benefit from one or more interventions, and,
for each patient represented in the subset of patient health records and for each of the one or more interventions,
determine whether an order for the intervention already exists for the patient, and,
if it is determined that an order for the intervention does not already exist for the patient, generate an order for the intervention.

12. The system of claim 11, wherein the one or more executable software modules are further configured to, for each patient represented in the subset of patient health records and for each of the one or more interventions, if an order for the intervention is generated, notify a physician associated with the patient of the generated order.

13. The system of claim 12, wherein the one or more executable software modules are further configured to, for one or more orders, receive a verification of the order.

14. The system of claim 13, wherein the verification comprises an indication of approval by a physician.

15. The system of claim 11, wherein the one or more executable software modules are further configured to:
identify an inactive subset of orders from a plurality of orders; and,
for each of the inactive subset of orders,
determine whether the order has been verified, and,
if it is determined that the order has been verified, activate the order and send a notification to a patient associated with the order.

16. The system of claim 15, wherein the notification comprises one or more of a telephone call, email message, secure message, text message, multimedia message, letter, and postcard.

17. The system of claim 11, wherein the one or more criteria comprise an upcoming appointment.

18. The system of claim 11, wherein the one or more executable software modules are further configured to, for each patient represented in the subset of patient health records:
determine whether the patient has an upcoming appointment; and,
if it is determined that the patient has an upcoming appointment, distinguish the patient from other patients that do not have an upcoming appointment.

19. The system of claim 11, wherein the one or more interventions comprise one or more of a laboratory test and consultation.

20. The system of claim 11, wherein each of the plurality of patient health records comprises one or more of existing orders, clinical notes, demographic information, and clinical reports for the associated patient.
